(19) United States
(12) Patent Application Publication
(10) Pub. No.: US 2025/0224767 A1
(43) Pub. Date: Jul. 10, 2025

(54) MANUFACTURING PROCESS FOR WEARABLE RING DEVICE

(71) Applicant: Oura Health Oy, Oulu (FI)

(72) Inventors: Teemu Juhani Haverinen, Oulu (FI); Marko Uusitalo, Oulu (FI); Pasi Koski, Ylikiiminki (FI); Bernadette Kostet, Liminka (FI); Antti Kalevi Lämsä, Oulu (FI)

(21) Appl. No.: 19/006,825

(22) Filed: Dec. 31, 2024

Related U.S. Application Data
(60) Provisional application No. 63/617,612, filed on Jan. 4, 2024.

(51) Int. Cl. G06F 1/16; G06F 3/01

(52) U.S. Cl. CPC G06F 1/163; G06F 1/1635; G06F 1/1698; G06F 3/014

(57) ABSTRACT

Methods for manufacturing a wearable ring device are described. The method includes detachably coupling a printed circuit board (PCB) to an inner shell to align sensors of the PCB with apertures of the inner shell, where the PCB is disposed between side walls on respective lateral sides of the inner shell. The method further includes disposing a cover assembly around the circumference of the inner shell, where a mechanical deformation of the cover assembly causes the cover assembly to contact the side walls around the circumference of the inner shell, and where the cover assembly is configured to exert a force on the PCB to secure the PCB against the inner shell. The method further includes surrounding at least a portion of the cover assembly with an outer shell, the outer shell defining at least a portion of an outer curved surface of the wearable ring device.

### CROSS-REFERENCE

The present Application for Patent claims the benefit of U.S. Provisional Patent Application No. 63/617,612 by HAVERINEN et al., entitled “TECHNIQUES FOR MANUFACTURING A WEARABLE RING DEVICE,” filed Jan. 4, 2024, assigned to the assignee hereof, and expressly incorporated by reference herein.

### FIELD OF TECHNOLOGY

The following relates to wearable devices and data processing, including a manufacturing process for wearable ring devices.

### BACKGROUND

Some wearable devices may be configured to collect data from users to help the users understand more about their overall physiological health and well-being. However, manufacturing the wearable devices can be a complicated and expensive process, and may leave vast room for human error.

### BRIEF DESCRIPTION OF THE DRAWINGS

FIG. 1 illustrates an example of a system that supports a manufacturing process for wearable ring devices in accordance with aspects of the present disclosure.

FIG. 2 illustrates an example of a system that supports a manufacturing process for wearable ring devices in accordance with aspects of the present disclosure.

FIGS. 3-6 show example manufacturing diagrams that support a manufacturing process for wearable ring devices in accordance with aspects of the present disclosure.

FIG. 7 shows a cross-sectional view of a wearable ring device manufactured in accordance with aspects of the present disclosure.

FIGS. 8 through 10 show flowcharts illustrating methods for a manufacturing process for wearable ring devices in accordance with aspects of the present disclosure.

### DETAILED DESCRIPTION

Some wearable ring devices are manufactured with an “inner shell” (e.g., inner housing) and an “outer shell” (e.g., outer housing) where components of the wearable ring device are disposed (at least partially) within a cavity defined by the inner shell and the outer shell. During the manufacturing process, a printed circuit board (PCB) (which includes sensors and other electrical components of the ring) may be placed around the inner shell, and an epoxy molding process may be used to attach the PCB to the inner shell and form lenses within the inner shell. Subsequently, the outer cover may be slid around the inner shell, the PCB, and the epoxy-molded material. While the epoxy molding process may create a water-tight seal and hold the PCB firmly in place, it can cause several issues. First, the epoxy molding process may be tedious and time consuming to implement. Second, once the epoxy has hardened, it is difficult (if not impossible) to remove the epoxy. As such, if any part of the manufacturing process goes wrong during (or following) the epoxy molding process, the entire ring must be discarded, leading to increased waste and material costs. Third, because the epoxy can not be removed once hardened, components of the ring (e.g., battery, sensors, etc.) may not be easily repaired or replaced.

Accordingly, aspects of the present disclosure are directed to a manufacturing process for wearable ring devices that does not include an epoxy molding process. Instead, components of a wearable ring device may be detachably coupled to an inner shell and sealed inside the ring with a “cover assembly” (which may be different from the outer shell/cover) that can be removed to allow for easy battery replacement, sensor repair, etc. As such, by facilitating a manufacturing process where components may be easily detached and replaced, aspects of the present disclosure may lead to a more ecologically-friendly manufacturing process that results in less wasted materials as compared to other manufacturing processes.

For example, in accordance with a manufacturing process described herein, optical lenses for a wearable ring device may be formed within an inner shell of the wearable ring device before the PCB or other components are installed within the ring. As compared to previous epoxy molding procedures used to form lenses, which are performed over the PCB and other components, molding the lenses directly onto/within the inner shell without the presence of the PCB or other components enables new materials and/or molding procedures to be used that result in higher quality lenses (and improved optical performance). Additionally, or alternatively, the optical lenses may be formed over the sensors of the PCB prior to connecting the PCB to the inner shell such that the optical lenses fit within apertures of the inner shell.

Following formation of the optical lenses, the PCB, battery, and other components of the ring may be detachably coupled to the inner shell. Subsequently, a “cover assembly” may be stretched around the ring to create a water-tight seal with the inner shell. Lastly, an outer shell (e.g., outer metal shell, outer cover, outer ring-shaped housing) may be installed around the cover assembly to finish the wearable ring device. Without the use of an epoxy molding process that seals the cover assembly and/or the outer shell to the ring, the outer shell and cover assembly may be (relatively) easily removed, such as to replace the battery or other components of the ring.

As compared to previous epoxy-based manufacturing techniques in which the entire ring has to be discarded if a single step of the manufacturing process is not performed correctly, the manufacturing process described herein may enable the respective parts of the ring to be disassembled and replaced throughout the manufacturing process and/or following completion of the manufacturing process. Therefore, techniques described herein may lead to less wasted components and resources, reduced manufacturing costs, and a more ecologically-friendly manufacturing process for wearable devices.

For the purposes of the present disclosure, the term “curved,” “circumferential,” and like terms, may be used interchangeably to refer to any surface or shape that exhibits a curved profile or contour. As such, the terms “curved” and “circumferential,” may be used to refer to surfaces/shapes that are circular, elliptical, etc., unless noted otherwise herein. Similarly, the term “circumference” may be used to refer to the shape of a wearable ring device that wraps radially around a user's finger (e.g., 360° perimeter or shape), and is not to be interpreted as referring solely to a perfectly circular or elliptical shape. That is, the term “circumference” may be used to refer to any radial span that extends radially (e.g., 360°) around the ring. For example, a wearable ring device may be said to have a “circumference” that wraps radially around the user's finger even in cases where the ring itself is not a perfect circle. That is, wearable ring devices with an elliptical shape, flat portions, etc. may still be said to exhibit a “circumference” in that the wearable ring devices exhibit a shape/perimeter that wraps around a user's finger.

Aspects of the disclosure are initially described in the context of systems supporting physiological data collection from users via wearable devices. Additional aspects of the disclosure are directed to manufacturing diagrams and a cross-sectional view of a wearable ring device. Aspects of the disclosure are further illustrated by and described with reference to apparatus diagrams, system diagrams, and flowcharts that relate to a manufacturing process for wearable ring devices.

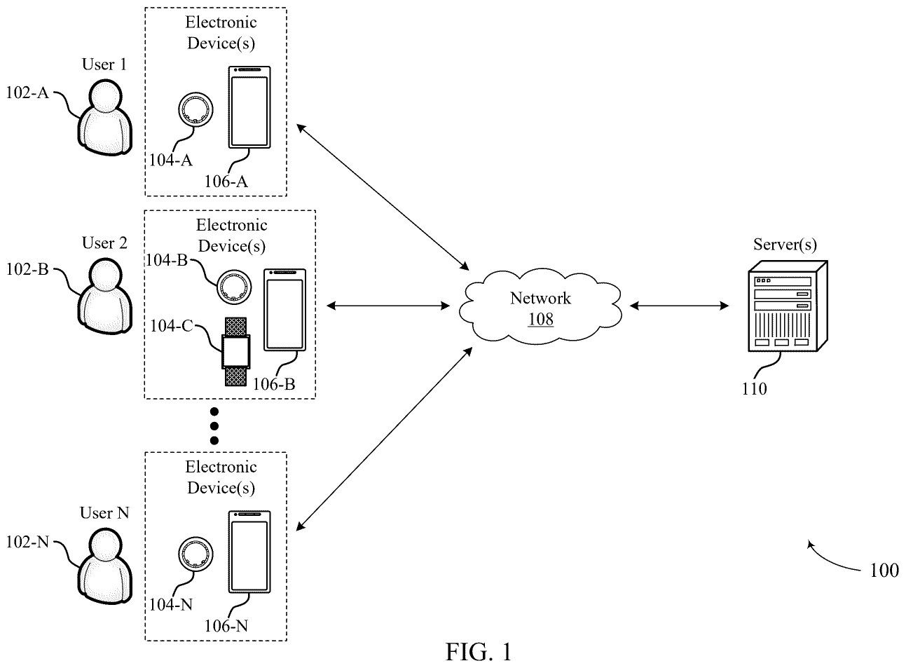

FIG. 1 illustrates an example of a system 100 that supports a manufacturing process for wearable ring devices in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g., in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some aspects, the wearable devices 104 (e.g., wearable ring devices 104) of the system 100 may be manufactured in accordance with manufacturing processes described herein. For example, in accordance with a manufacturing process described herein, optical lenses for a wearable ring device 104 of the system 100 may be formed within an inner shell of the wearable ring device 104 before the PCB or other components are installed within the ring. Additionally, or alternatively, the optical lenses may be formed over the sensors of the PCB prior to connecting the PCB to the inner shell such that the optical lenses fit within apertures of the inner shell.

Following formation of the optical lenses, the PCB, battery, and other components of the wearable ring device 104 may be detachably coupled to the inner shell. Subsequently, a “cover assembly” may be stretched around the ring to create a water-tight seal with the inner shell. Lastly, an outer shell (e.g., outer metal shell) may be installed around the cover assembly to finish the wearable ring device 104. Without the use of an epoxy molding process that seals the cover assembly and/or the outer shell to the wearable ring device 104, the outer shell and cover assembly may be (relatively) easily removed, such as to replace the battery or other components of the wearable ring device 104.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

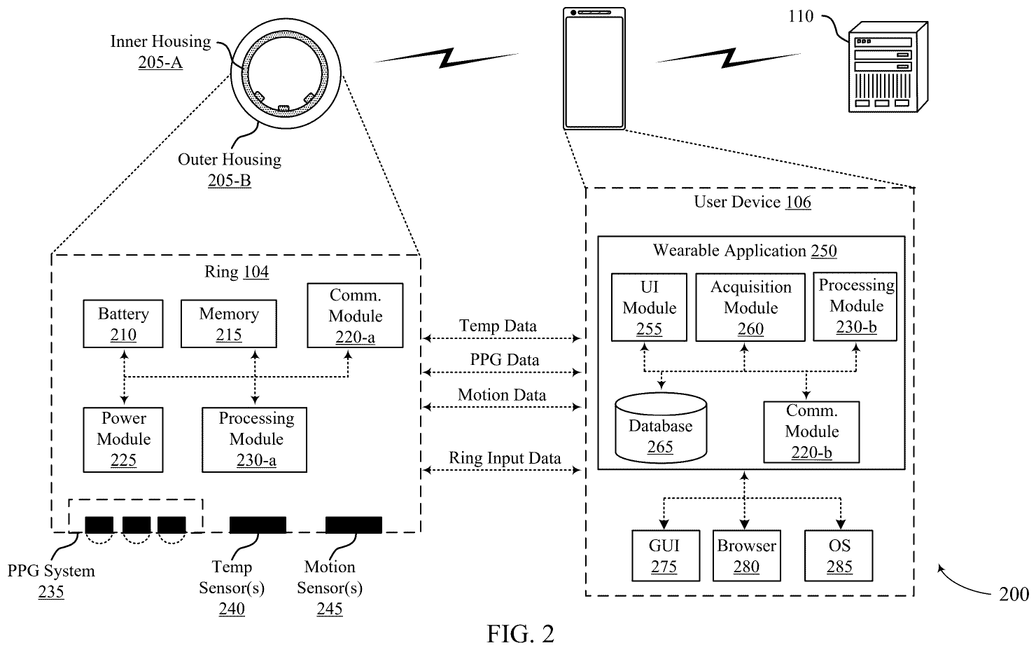

FIG. 2 illustrates an example of a system 200 that supports a manufacturing process for wearable ring devices in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106). In some implementations, the communication modules 220-a, 220-b may include wireless communication circuits, such as Bluetooth circuits and/or Wi-Fi circuits. In some implementations, the communication modules 220-a, 220-b can include wired communication circuits, such as Universal Serial Bus (USB) communication circuits. Using the communication module 220-a, the ring 104 and the user device 106 may be configured to communicate with each other. The processing module 230-a of the ring may be configured to transmit/receive data to/from the user device 106 via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS) 285, a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

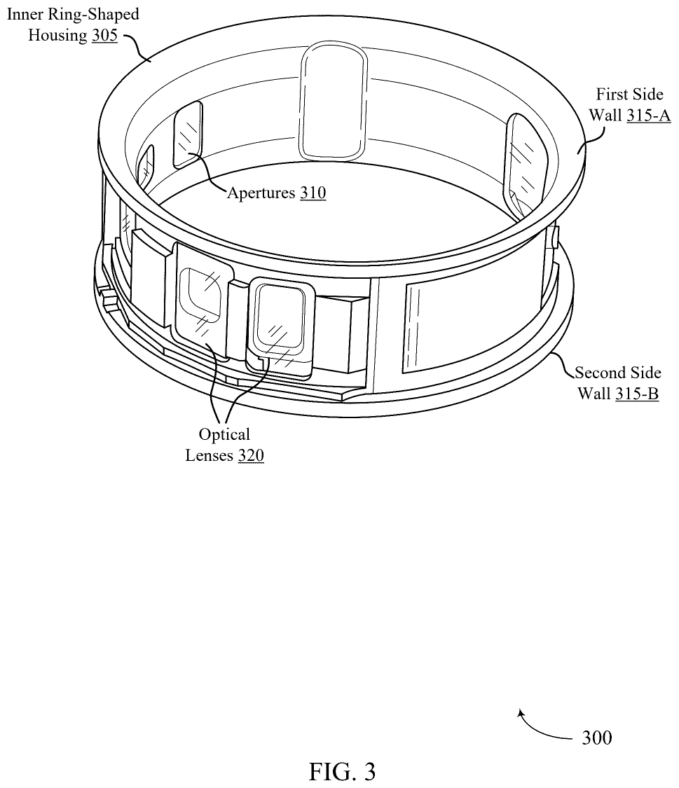

In some aspects, the wearable device 104 (e.g., wearable ring device 104) of the system 200 may be manufactured in accordance with manufacturing processes described herein. Attendant advantages of the manufacturing process of the present disclosure are further shown and described with reference to FIGS. 3-7.

FIG. 3 shows an example of a manufacturing diagram 300 that supports a manufacturing process for wearable ring devices 104 in accordance with aspects of the present disclosure. Aspects of the manufacturing diagram 300 may implement, or be implemented by, aspects of the system 100, the system 200, or both. For example, the manufacturing diagram 300 illustrated in FIG. 3 may be used to manufacture the wearable devices (e.g., wearable ring devices 104) shown and described in FIGS. 1 and 2.

In accordance with a manufacturing process described herein, one or more optical lenses 320 may be formed on/within one or more apertures 310 of an inner ring-shaped housing 305 (e.g., “inner shell”). For example, as shown in FIG. 3, the inner ring-shaped housing 305 may include one or more apertures 310, where optical lenses 320 are formed over (and/or at least partially within) the apertures 310. In some cases, the optical lenses 320 may be formed by placing the inner ring-shaped housing 305 into a mold structure, where an injection molding procedure and/or epoxy molding procedure is performed to form the optical lenses 320. In such cases, an epoxy material (or other material) may be injected into the mold structure to form the optical lenses 320. Additionally, or alternatively, the optical lenses 320 may be made from other materials, such as glass, ceramics (e.g., optically-translucent ceramics), plastic materials, etc.

In some cases, the optical lenses 320 may be manufactured such that a surface of the optical lenses 320 is substantially flush with the inner curved surface (e.g., inner circumferential surface) of the inner ring-shaped housing 305. In other cases, the optical lenses 320 may be manufactured with a “dome” or other convex shape that extends from the inner curved surface of the inner ring-shaped housing 305.

In some aspects, the optical lenses 320 may be formed such that the optical lenses 320 include one or more recesses (e.g., recesses facing the interior of the ring) that are configured to receive sensors or other electrical components (e.g., LEDs, PDs). For example, mold structure may include “protrusions” or other mechanical structures that form corresponding “recesses” within the optical lenses 320. In some cases, the recesses may result in optical lenses 320 that are thicker in some areas (areas without the recesses), and thinner in other areas (areas with the recesses). As will be described in further detail herein, recesses within the optical lenses 320 may enable sensors of the wearable ring device 104 (e.g., LEDs, PDs) to be moved into the recesses (and therefore moved further into the apertures 310), thereby moving the sensors closer to the inner curved surface (e.g., inner circumferential surface) of the inner ring-shaped housing 305.

In some cases, the material used to perform the optical lenses 320 may include a substantially transparent material that enables light to easily and efficiently travel through the optical lenses 320 (e.g., epoxy, glass, optically-translucent ceramics, plastic materials, etc.). As noted previously herein, in some conventional manufacturing techniques, an epoxy molding procedure may be used to form optical lenses 320 by molding the optical lenses over/around a PCB placed within the inner ring-shaped housing 305. In such cases, the temperatures and materials used to perform the epoxy molding procedure must be selected and controlled so as not to damage the components of the PCB. Comparatively, this constraint is alleviated in cases where the optical lenses 320 are formed directly onto/within (and formed separately and subsequently attached to) the inner ring-shaped housing 305 without the presence of a PCB (or other electrical components), as shown in FIG. 3. As such, the manufacturing process described herein may enable the optical lenses 320 to be formed using higher temperatures and/or different materials that would otherwise damage a PCB and/or other electrical components in other manufacturing processes.

In some aspects, the inner ring-shaped housing 305 may be manufactured using one or more metallic materials, plastic materials, epoxy materials, ceramic materials, glass materials, or any combination thereof. The inner ring-shaped housing 305 may define an inner curved surface (e.g., inner circumferential surface) of the wearable ring device 104, where the inner curved surface is configured to (at least partially) contact a tissue of a user in order to collect physiological data from the user. As shown in FIG. 3, the inner ring-shaped housing 305 may exhibit a concave or “U” shape. For example, the inner ring-shaped housing 305 may include a first side wall 315-a and a second side wall 315-b on respective lateral sides of the wearable ring device 104, where the side walls 315-a, 315-b span at least a portion of a circumference (e.g., outer perimeter) of the wearable ring device 104.

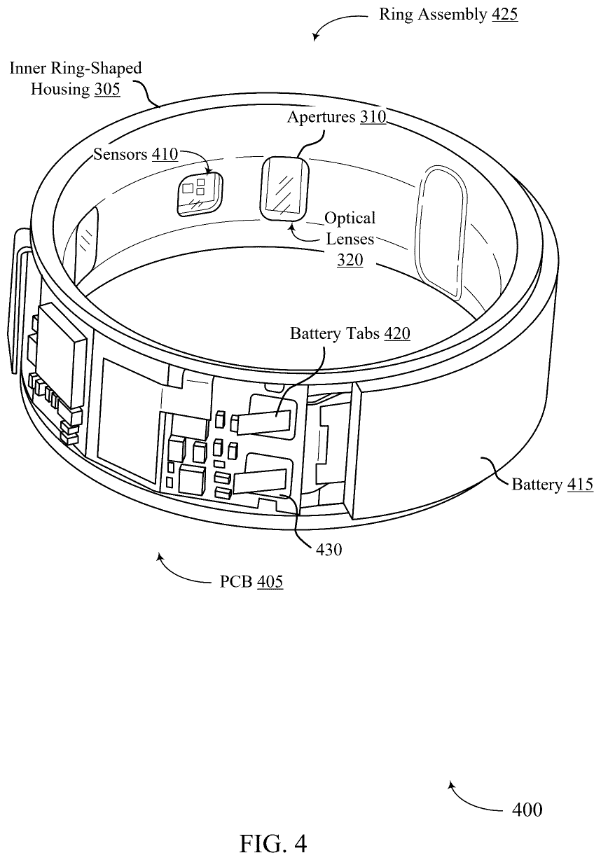

FIG. 4 shows an example of a manufacturing diagram 400 that supports a manufacturing process for wearable ring devices in accordance with aspects of the present disclosure. Aspects of the manufacturing diagram 400 may implement, or be implemented by, aspects of the system 100, the system 200, the manufacturing diagram 300, or any combination thereof. For example, the manufacturing diagram 400 illustrated in FIG. 4 may illustrate a continuation of the manufacturing diagram 300 illustrated in FIG. 3.

In some aspects, a PCB 405 may be detachably coupled with the inner ring-shaped housing 305. In particular, the PCB 405 may be detachably coupled with the inner ring-shaped housing 305 between the first side wall 315-a and the second side wall 315-b of the inner ring-shaped housing 305, as shown in FIG. 3. The PCB 405 may be said to be “detachably coupled” to the inner ring-shaped housing 305 in that the PCB 405 may be easily removed without damaging the PCB 405 and/or inner ring-shaped housing 305. For example, the PCB 405 may include a first set of locking features (e.g., a set of tabs), and the inner ring-shaped housing 305 may include a second set of locking features (e.g., a set of detents), where the PCB 405 is detachably coupled with the inner ring-shaped housing 305 by engaging the first set of locking features with the second set of locking features.

The PCB 405 may be coupled with the inner ring-shaped housing 305 such that sensors 410 of the PCB 405 (e.g., LEDs, PDs) are aligned with the one or more apertures 310 of the inner ring-shaped housing 305. In this regard, the first set of locking features of the PCB 405 may be configured to engage with the second set of locking features of the inner ring-shaped housing 305 in a defined orientation/configuration such that sensors 410 of the PCB 405 are radially aligned with respect to the apertures 310 and optical lenses 320. In this regard, the PCB 405 may be detachably coupled with the inner ring-shaped housing 305 such that the one or more sensors 410 are disposed at least partially within the one or more apertures 310.

For example, in cases where the optical lenses 320 include one or more recesses, the sensors 410 (e.g., LEDs, PDs) of the PCB 405 may be disposed at least partially within the recesses of the optical lenses 320. By moving the sensors 410 up into the recesses of the optical lenses 320, the sensors 410 may be moved closer to the inner curved surface of the inner ring-shaped housing 305, and therefore closer to the tissue of the user, which may lead to more accurate and reliable physiological measurements performed by the sensors 410. Moreover, disposing the sensors 410 within the recesses of the optical lenses 320 (and therefore further into the apertures 310 toward the inner curved surface) may lead to less light transmitted by the sensors 410 (e.g., LEDs) being reflected off the inner ring-shaped housing 305 back into the ring, which may reduce “light noise” observed by PDs, and therefore more accurate physiological measurements.

In some implementations, the surface of the inner ring-shaped housing 305 may include one or more protective layers, where the PCB 405 is detachably coupled with the inner ring-shaped housing 305 such that a surface of the PCB 405 contacts the one or more protective layers of the inner ring-shaped housing 305. In such cases, the protective layers may be configured to provide shock resistance, thermal insulation, electrical insulation, or any combination thereof, between the PCB 405 and the inner ring-shaped housing 305. In this regard, in some cases, the protective layers may not be manufactured directly onto/within the inner ring-shaped housing 305, but may rather be inserted between the PCB 405 and the inner ring-shaped housing 305 during the manufacturing process as separate, standalone layers.

In some aspects, a battery 415 may be coupled with the PCB 405 and/or inner ring-shaped housing 305. For example, a battery 415 may be detachably coupled with the PCB 405 using one or more battery tabs 420. For instance, the battery tabs 420 may be inserted into/through pass-throughs 430 (e.g., electrically-conductive ports) of the PCB 405, where the battery 415 may be easily decoupled from the PCB 405 by removing the battery tabs 420 from the pass-throughs 430. In additional or alternative cases, the battery 415 may be detachably coupled with the PCB 405 by inserting the battery tabs 420 into one or more conductive battery ports of the PCB 405.

In some alternative implementations, instead of forming the optical lenses 320 directly on/within the inner ring-shaped housing 305, the optical lenses 320 may be molded or otherwise formed over the sensors 410 of the PCB 405 prior to connecting the PCB 405 with the inner ring-shaped housing 305. For example, dome-shaped optical lenses 320 may be formed over the sensors 410 of the PCB 405, where the PCB 405 is subsequently coupled with the inner ring-shaped housing 305 such that the dome-shaped optical lenses 320 are inserted into (and substantially fill) the apertures 310 of the inner ring-shaped housing 305.

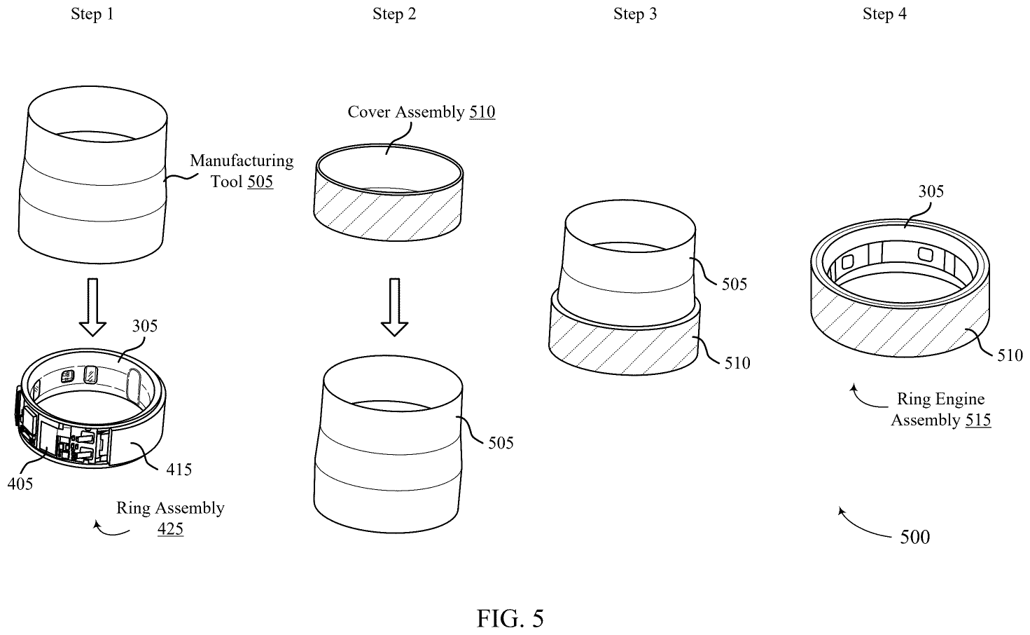

Taken together, the manufacturing diagram 400 illustrated in FIG. 4 may result in a ring assembly 425 that includes the inner ring-shaped housing 305, the PCB 405, and the battery 415. The ring assembly 425 is further shown and described in FIG. 5.

FIG. 5 shows an example of a manufacturing diagram 500 that supports a manufacturing process for wearable ring devices in accordance with aspects of the present disclosure. Aspects of the manufacturing diagram 500 may implement, or be implemented by, aspects of the system 100, the system 200, the manufacturing diagram 300, the manufacturing diagram 400, or any combination thereof. For example, the manufacturing diagram 500 illustrated in FIG. 5 may illustrate a continuation of the manufacturing diagrams 300 and 400 illustrated in FIGS. 3 and 4, respectively.

As shown in the manufacturing diagram 500, one or more manufacturing tools 505 may be used to couple a cover assembly 510 to/around the ring assembly 425 shown and described in FIG. 4. For example, as shown in Step 1, a manufacturing tool 505 may be placed around the ring assembly 425. The manufacturing tool 505 may be tapered such that a top side of the manufacturing tool 505 has a smaller radius/circumference as compared to a bottom side of the manufacturing tool 505. In such cases, the inner radius/circumference of the bottom side of the manufacturing tool 505 may substantially correspond to an outer radius/circumference of the ring assembly 425.

In Steps 2 and 3, a cover assembly 510 may be placed on and/or slid around the manufacturing tool 505. In particular, the cover assembly 510 may be initially placed around the top side (e.g., narrower side) of the manufacturing tool 505, and subsequently slid down to the bottom side (e.g., wider side) of the manufacturing tool 505. In some cases, the taper of the manufacturing tool 505 may cause the cover assembly 510 to expand/stretch from a first size (initial size) to a second size (bigger size) as the cover assembly 510 is moved from the narrower side to the wider side of the manufacturing tool 505. In this regard, the cover assembly 510 may be made of a material that is mechanically deformable, such as a rubber material, an elastomer material, a plastic material, etc.

Between Step 3 and Step 4, the manufacturing tool 505 may be removed. The removal of the manufacturing tool 505 may cause a mechanical deformation of the cover assembly 510 that causes the cover assembly 510 to shrink/contract and contact the ring assembly 425. In particular, the mechanical deformation of the cover assembly 510 (which is caused at least in part by the removal of the manufacturing tool 505) may cause the cover assembly 510 to contract/shrink, thereby causing the cover assembly 510 to contact the first side wall 315-a and the second side wall 315-b of the inner ring-shaped housing 305 of the ring assembly 425. Together, the cover assembly 510 and the inner ring-shaped housing 305 may form a ring engine assembly 515, where the cover assembly 510 at least partially surrounds a circumference (e.g., outer perimeter) of the inner ring-shaped housing 305.

In some aspects, the cover assembly 510 may be configured to exert a force on the PCB 405 to secure the PCB 405 against the inner ring-shaped housing 305. Similarly, the cover assembly 510 may be configured to exert a force on the battery 415 to secure the battery 415 against the inner ring-shaped housing 305. In some aspects, the cover assembly 510 may form a water-tight and/or air-tight seal against the inner ring-shaped housing 305 to prevent water and debris from entering and damaging the ring. That is, the cover assembly 510 may serve as a “wide sealant” or “wide side cover” that serves to seal and protect the components of the ring.

In some cases, the ring assembly 425 may additionally include a compressible material, such as a foam material, that at least partially surrounds a circumference of the ring assembly 425. That is, a compressible material may be placed on top of the PCB 405 and/or the battery 415 of the ring assembly 425. In such cases, the cover assembly 510 may be placed around the circumference of the ring assembly 425 (e.g., around the circumference of the inner ring-shaped housing 305) such that the cover assembly 510 compresses the compressible material, and causes the compressible material to exert the force against the PCB 405 and/or the battery 415. In this regard, the compressible material may substantially fill any gaps between the PCB 405/battery 415 and the cover assembly 510. Moreover, the compressible material may protect components of the PCB 405 (e.g., sensors 410) as the cover assembly 510 is coupled to the inner ring-shaped housing 305 of the ring assembly 425.

In additional or alternative implementations, instead of expanding a size of the cover assembly 510 with the manufacturing tool 505 (as shown and described in FIG. 5), the cover assembly 510 may be made to be slightly larger than the inner ring-shaped housing 305 of the ring assembly 425, where a manufacturing tool may be used to compress the cover assembly 510 around the ring assembly 425 to form the ring engine assembly 515. In this regard, the cover assembly 510 may be easily slid around the ring assembly 425 due to the larger size of the cover assembly 510, and a manufacturing tool may be used to compress the cover assembly 510 onto/around the ring assembly 425 to couple the cover assembly 510 with the inner ring-shaped housing 305.

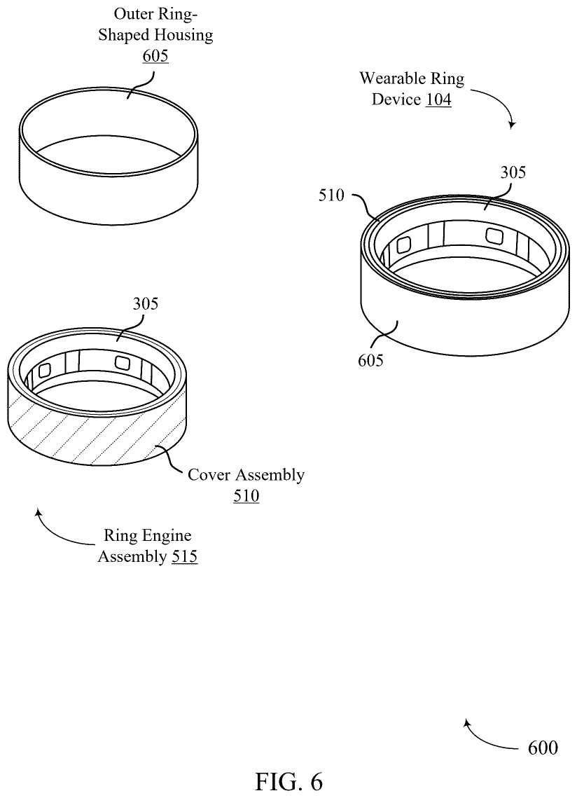

FIG. 6 shows an example of a manufacturing diagram 600 that supports a manufacturing process for wearable ring devices in accordance with aspects of the present disclosure. Aspects of the manufacturing diagram 600 may implement, or be implemented by, aspects of the system 100, the system 200, the manufacturing diagram 300, the manufacturing diagram 400, the manufacturing diagram 500, or any combination thereof. For example, the manufacturing diagram 600 illustrated in FIG. 6 may illustrate a continuation of the manufacturing diagrams 300, 400, and 500 illustrated in FIGS. 3-5.

In some aspects, as part of the manufacturing process for the wearable ring device 104, an outer ring-shaped housing 605 (e.g., outer shell) may be placed over/around the ring engine assembly 515 such that the outer ring-shaped housing 605 surrounds at least a portion of the ring engine assembly 515. For example, as shown in FIG. 6, the outer ring-shaped housing 605 may at least partially surround the cover assembly 510 of the ring engine assembly 515 in order to form the wearable ring device 104. In this example, the inner ring-shaped housing 305 may define an inner curved surface (e.g., inner circumferential surface) of the wearable ring device 104, and the outer ring-shaped housing 605 may define an outer curved surface (e.g., outer circumferential surface) of the wearable ring device 104. In additional or alternative implementations, the cover assembly 510 may include or otherwise serve as the outer ring-shaped housing 605 such that the cover assembly 510 defines the outer curved surface of the wearable ring device 104.

The outer ring-shaped housing 605 may be manufactured of any material, such as a metallic material, a plastic material, an epoxy material, a rubber material, or any combination thereof. For example, the inner ring-shaped housing 305 and the outer ring-shaped housing 605 may be manufactured of the same (or different) metallic material(s). In some cases, the outer ring-shaped housing 605 may be detachably coupled with the cover assembly 510 and/or the inner ring-shaped housing 305 so that the outer ring-shaped housing 605 may be easily removed and/or exchanged with different outer ring-shaped housings (e.g., “swappable” outer ring shells). Such capabilities may enable components of the ring to be easily accessed, repaired, and/or exchanged (e.g., easily exchange the battery 415).

In some cases, the outer ring-shaped housing 605 may include mechanical features (e.g., locking features) that are configured to engage with corresponding mechanical/locking features on the cover assembly 510 and/or the inner ring-shaped housing 305. In additional or alternative implementations, one or more “side covers” may be used to attach the outer ring-shaped housing 605 to the wearable ring device 104, where the side covers are positioned between the outer ring-shaped housing 605 and the cover assembly 510/inner ring-shaped housing 305 on respective lateral sides of the ring.

In some cases, the outer ring-shaped housing 605 may exert a force on the cover assembly 510 that helps couple the cover assembly 510 to the inner ring-shaped housing 305. That is, a force exerted by the outer ring-shaped housing 605 may help form a water-tight and/or air-tight seal against the inner ring-shaped housing 305 to prevent water and debris from entering and damaging the ring. For example, in some cases, surrounding the ring engine assembly 515 with the outer ring-shaped housing 605 may cause a mechanical deformation of the cover assembly 510 that is configured to secure the outer ring-shaped housing 605 to the wearable ring device 104, secure the cover assembly 510 to the inner ring-shaped housing 305, or both. That is, a mechanical deformation of the cover assembly 510 may serve to “lock” the respective components of the wearable ring device 104 together.

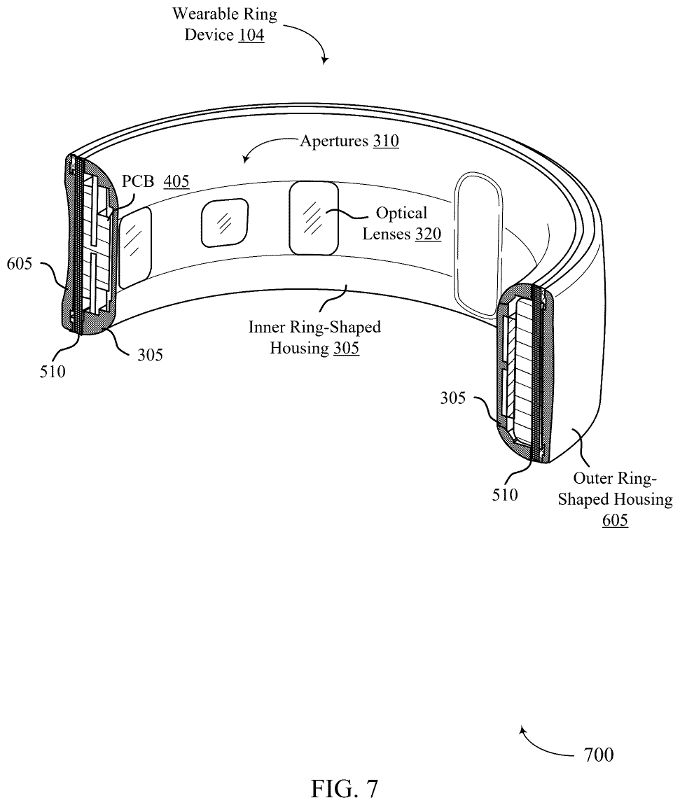

FIG. 7 shows a cross-sectional view 700 of a wearable ring device 104 manufactured in accordance with aspects of the present disclosure. Aspects of the wearable device 104 shown in the cross-sectional view 700 may implement, or be implemented by, aspects of the system 100, the system 200, the manufacturing diagram 300, the manufacturing diagram 400, the manufacturing diagram 500, the manufacturing diagram 600, or any combination thereof. For example, the cross-sectional view 700 illustrated in FIG. 7 may include an example cross-sectional view of a wearable device 104 that is manufactured in accordance with the manufacturing diagrams 300, 400, 500, and 600 illustrated in FIGS. 3-6.

As described previously herein, the wearable ring device 104 manufactured according to the manufacturing process of the present disclosure may include the inner ring-shaped housing 305, the cover assembly 510, and the outer ring-shaped housing 605. The PCB 405 may be positioned at least partially within a cavity defined by the inner ring-shaped housing 305 and the cover assembly 510/outer ring-shaped housing 605.

The inner ring-shaped housing 305 may include one or more apertures 310 that are used for collecting physiological data from the user, where the apertures 310 may include (e.g., be substantially filled with) one or more optical lenses 320. As described previously herein, the one or more optical lenses 320 may be formed directly onto/within the inner ring-shaped housing 305 prior to coupling the PCB 405 to the inner ring-shaped housing 305. In alternative cases, the optical lenses 320 may be formed directly onto the PCB 405 such that, when the PCB 405 is subsequently coupled with the inner ring-shaped housing 305, the optical lenses 320 are inserted into (and/or substantially fill) the apertures 310.

In some implementations, the outer curved surface of the inner ring-shaped housing 305 may include one or more protective layers, where the PCB 405 is detachably coupled with the inner ring-shaped housing 305 such that a surface of the PCB 405 contacts the one or more protective layers of the inner ring-shaped housing 305. In such cases, the protective layers may be configured to provide shock resistance, thermal insulation, electrical insulation, or any combination thereof, between the PCB 405 and the inner ring-shaped housing 305. In this regard, in some cases, the protective layers may not be manufactured directly onto/within the inner ring-shaped housing 305, but may rather be inserted between the PCB 405 and the inner ring-shaped housing 305 during the manufacturing process as separate, standalone layers.

As described previously herein, in some cases, the wearable ring device 104 may additionally include a compressible material, such as a foam material, between the PCB 405 and the cover assembly 510. In such cases, the cover assembly 510 may be configured to compress the compressible material, and cause the compressible material to exert the force against the PCB 405 and/or the battery 415. In this regard, the compressible material may substantially fill any gaps between the PCB 405/battery 415 and the cover assembly 510. Moreover, the compressible material may protect components of the PCB 405 (e.g., sensors 410) as the cover assembly 510 is coupled to the ring.

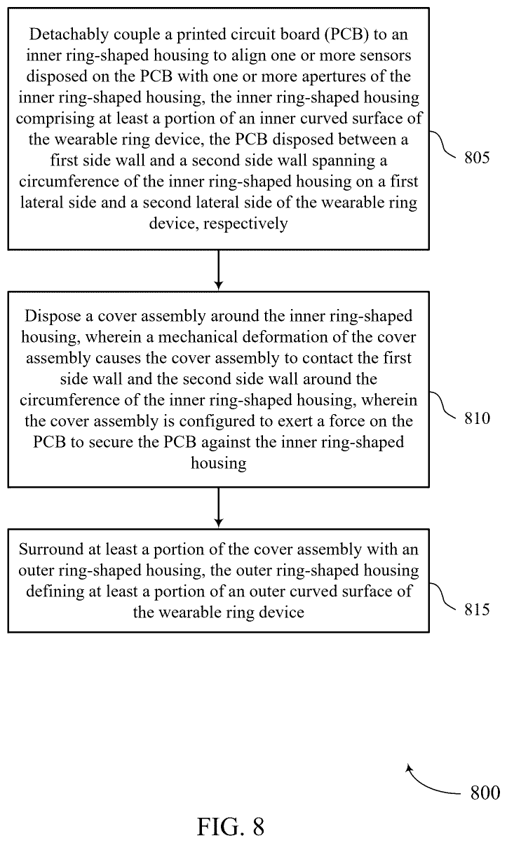

FIG. 8 shows a flowchart illustrating a method 800 that supports a manufacturing process for wearable ring devices in accordance with aspects of the present disclosure. The operations of the method 800 may be implemented by a wearable device or its components as described herein. For example, the operations of the method 800 may be performed by a wearable device as described with reference to FIGS. 1 through 7. In some examples, a wearable device may execute a set of instructions to control the functional elements of the wearable device to perform the described functions. Additionally, or alternatively, the wearable device may perform aspects of the described functions using special-purpose hardware.

At 805, the method may include detachably coupling a PCB to an inner ring-shaped housing to align one or more sensors disposed on the PCB with one or more apertures of the inner ring-shaped housing, the inner ring-shaped housing comprising/defining at least a portion of an inner curved surface of the wearable ring device, the PCB disposed between a first side wall and a second side wall spanning a circumference/perimeter of the inner ring-shaped housing on a first lateral side and a second lateral side of the wearable ring device, respectively. The operations of block 805 may be performed in accordance with examples as disclosed herein.

At 810, the method may include disposing a cover assembly around the circumference/perimeter of the inner ring-shaped housing, wherein a mechanical deformation of the cover assembly causes the cover assembly to contact the first side wall and the second side wall around the circumference/perimeter of the inner ring-shaped housing, wherein the cover assembly is configured to exert a force on the PCB to secure the PCB against the inner ring-shaped housing. The operations of block 810 may be performed in accordance with examples as disclosed herein.

At 815, the method may include surrounding at least a portion of the cover assembly with an outer ring-shaped housing, the outer ring-shaped housing defining at least a portion of an outer curved surface of the wearable ring device. The operations of block 815 may be performed in accordance with examples as disclosed herein.

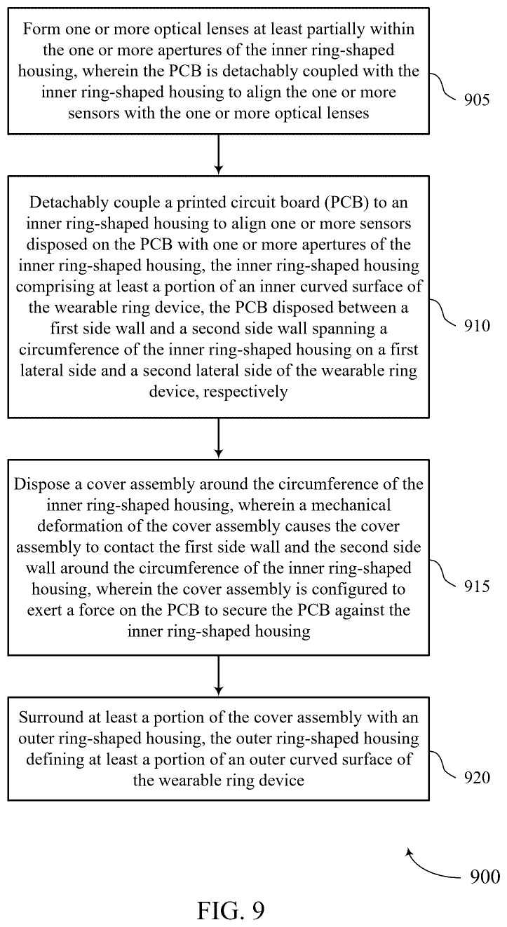

FIG. 9 shows a flowchart illustrating a method 900 that supports a manufacturing process for wearable ring devices in accordance with aspects of the present disclosure. The operations of the method 900 may be implemented by a wearable device or its components as described herein. For example, the operations of the method 900 may be performed by a wearable device as described with reference to FIGS. 1 through 7. In some examples, a wearable device may execute a set of instructions to control the functional elements of the wearable device to perform the described functions. Additionally, or alternatively, the wearable device may perform aspects of the described functions using special-purpose hardware.

At 905, the method may include forming one or more optical lenses at least partially within one or more apertures of an inner ring-shaped housing. The operations of block 905 may be performed in accordance with examples as disclosed herein.

At 910, the method may include detachably coupling a PCB to the inner ring-shaped housing to align the one or more sensors with the one or more optical lenses, the inner ring-shaped housing comprising/defining at least a portion of an inner curved surface of the wearable ring device, the PCB disposed between a first side wall and a second side wall spanning a circumference/perimeter of the inner ring-shaped housing on a first lateral side and a second lateral side of the wearable ring device, respectively. The operations of block 910 may be performed in accordance with examples as disclosed herein.

At 915, the method may include disposing a cover assembly around the circumference/perimeter of the inner ring-shaped housing, wherein a mechanical deformation of the cover assembly causes the cover assembly to contact the first side wall and the second side wall around the circumference/perimeter of the inner ring-shaped housing, wherein the cover assembly is configured to exert a force on the PCB to secure the PCB against the inner ring-shaped housing. The operations of block 915 may be performed in accordance with examples as disclosed herein.

At 920, the method may include surrounding at least a portion of the cover assembly with an outer ring-shaped housing, the outer ring-shaped housing defining at least a portion of an outer curved surface of the wearable ring device. The operations of block 920 may be performed in accordance with examples as disclosed herein.

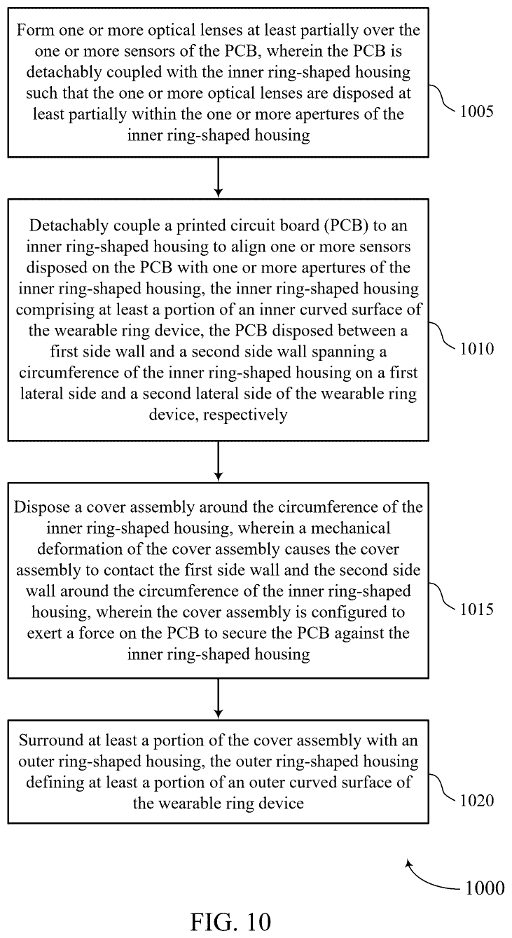

FIG. 10 shows a flowchart illustrating a method 1000 that supports a manufacturing process for wearable ring devices in accordance with aspects of the present disclosure. The operations of the method 1000 may be implemented by a wearable device or its components as described herein. For example, the operations of the method 1000 may be performed by a wearable device as described with reference to FIGS. 1 through 7. In some examples, a wearable device may execute a set of instructions to control the functional elements of the wearable device to perform the described functions. Additionally, or alternatively, the wearable device may perform aspects of the described functions using special-purpose hardware.

At 1005, the method may include forming one or more optical lenses at least partially over one or more sensors of a PCB. The operations of block 1005 may be performed in accordance with examples as disclosed herein.

At 1010, the method may include detachably coupling the PCB to an inner ring-shaped housing such that the one or more optical lenses are disposed at least partially within the one or more apertures of the inner ring-shaped housing, the inner ring-shaped housing comprising/defining at least a portion of an inner curved surface of the wearable ring device, the PCB disposed between a first side wall and a second side wall spanning a circumference/perimeter of the inner ring-shaped housing on a first lateral side and a second lateral side of the wearable ring device, respectively. The operations of block 1010 may be performed in accordance with examples as disclosed herein.

At 1015, the method may include disposing a cover assembly around the circumference/perimeter of the inner ring-shaped housing, wherein a mechanical deformation of the cover assembly causes the cover assembly to contact the first side wall and the second side wall around the circumference/perimeter of the inner ring-shaped housing, wherein the cover assembly is configured to exert a force on the PCB to secure the PCB against the inner ring-shaped housing. The operations of block 1015 may be performed in accordance with examples as disclosed herein.

At 1020, the method may include surrounding at least a portion of the cover assembly with an outer ring-shaped housing, the outer ring-shaped housing defining at least a portion of an outer curved surface of the wearable ring device. The operations of block 1020 may be performed in accordance with examples as disclosed herein.

It should be noted that the methods described above describe possible implementations, and that the operations and the steps may be rearranged or otherwise modified and that other implementations are possible. Furthermore, aspects from two or more of the methods may be combined.

A method for manufacturing a wearable ring device is described. The method may include detachably coupling a PCB to an inner ring-shaped housing to align one or more sensors disposed on the PCB with one or more apertures of the inner ring-shaped housing, the inner ring-shaped housing defining at least a portion of an inner curved surface of the wearable ring device, the PCB disposed between a first side wall and a second side wall spanning a circumference of the inner ring-shaped housing on a first lateral side and a second lateral side of the wearable ring device, respectively, disposing a cover assembly around the circumference of the inner ring-shaped housing, wherein a mechanical deformation of the cover assembly causes the cover assembly to contact the first side wall and the second side wall around the circumference of the inner ring-shaped housing, wherein the cover assembly is configured to exert a force on the PCB to secure the PCB against the inner ring-shaped housing, and surrounding at least a portion of the cover assembly with an outer ring-shaped housing, the outer ring-shaped housing defining at least a portion of an outer curved surface of the wearable ring device.

In some examples, the method of manufacturing may include forming one or more optical lenses at least partially within the one or more apertures of the inner ring-shaped housing, wherein the PCB may be detachably coupled with the inner ring-shaped housing to align the one or more sensors with the one or more optical lenses.

In some examples, the method of manufacturing may include disposing the inner ring-shaped housing into a mold structure and performing an injection molding procedure, an epoxy molding procedure, or both, to form the one or more optical lenses within the mold structure.

In some examples, the one or more optical lenses comprise one or more recesses configured to receive the one or more sensors and the PCB may be detachably coupled with the inner ring-shaped housing such that the one or more sensors may be disposed at least partially within the one or more recesses of the one or more optical lenses.

In some examples, the method of manufacturing may include forming one or more optical lenses at least partially over the one or more sensors of the PCB, wherein the PCB may be detachably coupled with the inner ring-shaped housing such that the one or more optical lenses may be disposed at least partially within the one or more apertures of the inner ring-shaped housing.

In some examples, the method of manufacturing may include disposing the cover assembly around the circumference of the inner ring-shaped housing may include operations, features, means, or instructions for expanding a size of the cover assembly from a first size to a second size with a manufacturing tool, wherein the mechanical deformation comprises a contraction of the cover assembly from the second size to the first size or a third size to cause the cover assembly to contact the first side wall and the second side wall around the circumference of the inner ring-shaped housing.

In some examples, the method of manufacturing may include compressing the cover assembly with a manufacturing tool to cause the mechanical deformation based at least in part on disposing the cover assembly around the circumference of the inner ring-shaped housing.

In some examples, the method of manufacturing may include disposing a compressible material over the PCB based at least in part on coupling the PCB to the inner ring-shaped housing, wherein disposing the cover assembly around the circumference of the inner ring-shaped housing causes the compressible material to compress and exert the force on the PCB to secure the PCB against the inner ring-shaped housing.

In some examples, the method of manufacturing may include detachably coupling a battery to the PCB, wherein the cover assembly may be configured to exert the force on the battery to secure the battery against the inner ring-shaped housing.

In some examples, the method of manufacturing may include exerting an additional force on the cover assembly with the outer ring-shaped housing based at least in part on surrounding the portion of the cover assembly with the outer ring-shaped housing, wherein the additional force causes an additional mechanical deformation of the cover assembly that may be configured to secure the outer ring-shaped housing to the wearable ring device.

In some examples, the PCB comprises a first set of locking features, the inner ring-shaped housing comprises a second set of locking features, and the PCB may be detachably coupled with the inner ring-shaped housing by engaging the first set of locking features with the second set of locking features.

In some examples, the inner ring-shaped housing comprises one or more protective layers, the PCB may be detachably coupled with the inner ring-shaped housing such that a surface of the PCB contacts the one or more protective layers, and the one or more protective layers may be configured to provide shock resistance, thermal insulation, electrical insulation, or any combination thereof, between the PCB and the inner ring-shaped housing.

In some examples, the inner ring-shaped housing, the outer ring-shaped housing, or both, comprise one or more metallic materials.

Another apparatus ring device is described. The apparatus may include an inner ring-shaped housing comprising one or more apertures, the inner ring-shaped housing defining at least a portion of an inner curved surface of the wearable ring device, a PCB detachably coupled with the inner ring-shaped housing such that one or more sensors disposed on the PCB are aligned with the one or more apertures, the PCB disposed between a first side wall and a second side wall spanning a circumference of the inner ring-shaped housing on a first lateral side and a second lateral side of the wearable ring device, respectively, one or more optical lenses coupled with the inner ring-shaped housing, the PCB, or both, wherein the one or more optical lenses substantially fill the one or more apertures, a cover assembly disposed around the circumference of the inner ring-shaped housing, wherein a mechanical deformation of the cover assembly causes the cover assembly to contact the first side wall and the second side wall around the circumference of the inner ring-shaped housing, wherein the cover assembly is configured to exert a force on the PCB to secure the PCB against the inner ring-shaped housing, and an outer ring-shaped housing surrounding at least a portion of the cover assembly, the outer ring-shaped housing defining at least a portion of an outer curved surface of the wearable ring device.

In some examples of the apparatus, the one or more optical lenses may be formed at least partially within the one or more apertures of the inner ring-shaped housing and the PCB may be detachably coupled with the inner ring-shaped housing to align the one or more sensors with the one or more optical lenses.

In some examples of the apparatus, forming the one or more optical lenses may be formed via an injection molding procedure, an epoxy molding procedure, or both.

In some examples of the apparatus, the one or more optical lenses comprise one or more recesses configured to receive the one or more sensors and the PCB may be detachably coupled with the inner ring-shaped housing such that the one or more sensors may be disposed at least partially within the one or more recesses of the one or more optical lenses.

In some examples of the apparatus, the one or more optical lenses may be formed at least partially over the one or more sensors of the PCB and the PCB may be detachably coupled with the inner ring-shaped housing such that the one or more optical lenses may be disposed at least partially within the one or more apertures of the inner ring-shaped housing.

Some examples of the apparatus may further include a compressible material disposed between the PCB and the cover assembly, wherein the cover assembly causes the compressible material to compress and exert the force on the PCB to secure the PCB against the inner ring-shaped housing.

Some examples of the apparatus may further include a battery that may be detachably coupled with the PCB, wherein the cover assembly may be configured to exert the force on the battery to secure the battery against the inner ring-shaped housing.

In some examples of the apparatus, the outer ring-shaped housing exerts an additional force on the cover assembly and the additional force causes an additional mechanical deformation of the cover assembly that may be configured to secure the outer ring-shaped housing to the wearable ring device.

In some examples of the apparatus, the PCB comprises a first set of locking features, the inner ring-shaped housing comprises a second set of locking features, and the PCB may be detachably coupled with the inner ring-shaped housing by engaging the first set of locking features with the second set of locking features.

In some examples of the apparatus, the inner ring-shaped housing comprises one or more protective layers, the PCB may be detachably coupled with the inner ring-shaped housing such that a surface of the PCB contacts the one or more protective layers, and the one or more protective layers may be configured to provide shock resistance, thermal insulation, electrical insulation, or any combination thereof, between the PCB and the inner ring-shaped housing.

In some examples of the apparatus, the inner ring-shaped housing, the outer ring-shaped housing, or both, comprise one or more metallic materials.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for manufacturing a wearable ring device, comprising:
detachably coupling a printed circuit board (PCB) to an inner ring-shaped housing to align one or more sensors disposed on the PCB with one or more apertures of the inner ring-shaped housing, the inner ring-shaped housing comprising at least a portion of an inner curved surface of the wearable ring device, the PCB disposed between a first side wall and a second side wall spanning at least a portion of a circumference of the inner ring-shaped housing on a first lateral side and a second lateral side of the wearable ring device, respectively;
disposing a cover assembly around the inner ring-shaped housing, wherein a mechanical deformation of the cover assembly causes the cover assembly to contact at least a portion of the first side wall and the second side wall around the circumference of the inner ring-shaped housing, wherein the cover assembly is configured to exert a force on the PCB to secure the PCB against the inner ring-shaped housing; and
surrounding at least a portion of the cover assembly with an outer ring-shaped housing, the outer ring-shaped housing defining at least a portion of an outer curved surface of the wearable ring device.

2. The method of claim 1, further comprising:
forming one or more optical lenses at least partially within the one or more apertures of the inner ring-shaped housing, wherein the PCB is detachably coupled with the inner ring-shaped housing to align the one or more sensors with the one or more optical lenses.

3. The method of claim 2, wherein forming the one or more optical lenses comprises:
disposing the inner ring-shaped housing into a mold structure; and
performing an injection molding procedure, an epoxy molding procedure, or both, to form the one or more optical lenses within the mold structure.

4. The method of claim 2, wherein the one or more optical lenses comprise one or more recesses configured to receive the one or more sensors, wherein the PCB is detachably coupled with the inner ring-shaped housing such that the one or more sensors are disposed at least partially within the one or more recesses of the one or more optical lenses.

5. The method of claim 1, further comprising:
forming one or more optical lenses at least partially over the one or more sensors of the PCB, wherein the PCB is detachably coupled with the inner ring-shaped housing such that the one or more optical lenses are disposed at least partially within the one or more apertures of the inner ring-shaped housing.

6. The method of claim 1, wherein disposing the cover assembly around the circumference of the inner ring-shaped housing comprises:
expanding a size of the cover assembly from a first size to a second size with a manufacturing tool, wherein the mechanical deformation comprises a contraction of the cover assembly from the second size to the first size or a third size to cause the cover assembly to contact the first side wall and the second side wall around the circumference of the inner ring-shaped housing.

7. The method of claim 1, further comprising:
compressing the cover assembly with a manufacturing tool to cause the mechanical deformation based at least in part on disposing the cover assembly around the circumference of the inner ring-shaped housing.

8. The method of claim 1, further comprising:
disposing a compressible material over the PCB based at least in part on coupling the PCB to the inner ring-shaped housing, wherein disposing the cover assembly around the circumference of the inner ring-shaped housing causes the compressible material to compress and exert the force on the PCB to secure the PCB against the inner ring-shaped housing.

9. The method of claim 1, further comprising:
detachably coupling a battery to the PCB, wherein the cover assembly is configured to exert the force on the battery to secure the battery against the inner ring-shaped housing.

10. The method of claim 1, further comprising:
exerting an additional force on the cover assembly with the outer ring-shaped housing based at least in part on surrounding the portion of the cover assembly with the outer ring-shaped housing, wherein the additional force causes an additional mechanical deformation of the cover assembly that is configured to secure the outer ring-shaped housing to the wearable ring device.

11. The method of claim 1, wherein the PCB comprises a first set of locking features, and wherein the inner ring-shaped housing comprises a second set of locking features, wherein the PCB is detachably coupled with the inner ring-shaped housing by engaging the first set of locking features with the second set of locking features.

12. The method of claim 1, wherein the inner ring-shaped housing comprises one or more protective layers, wherein the PCB is detachably coupled with the inner ring-shaped housing such that a surface of the PCB contacts the one or more protective layers, wherein the one or more protective layers are configured to provide shock resistance, thermal insulation, electrical insulation, or any combination thereof, between the PCB and the inner ring-shaped housing.

13. The method of claim 1, wherein the inner ring-shaped housing, the outer ring-shaped housing, or both, comprise one or more metallic materials.

14. A wearable ring device, comprising:
an inner ring-shaped housing comprising one or more apertures, the inner ring-shaped housing comprising at least a portion of an inner curved surface of the wearable ring device;
a printed circuit board (PCB) detachably coupled with the inner ring-shaped housing such that one or more sensors disposed on the PCB are aligned with the one or more apertures, the PCB disposed between a first side wall and a second side wall spanning at least a portion of a circumference of the inner ring-shaped housing on a first lateral side and a second lateral side of the wearable ring device, respectively;
one or more optical lenses coupled with the inner ring-shaped housing, the PCB, or both, wherein the one or more optical lenses substantially fill the one or more apertures;
a cover assembly disposed around the circumference of the inner ring-shaped housing, wherein a mechanical deformation of the cover assembly causes the cover assembly to contact at least a portion of the first side wall and the second side wall around the circumference of the inner ring-shaped housing, wherein the cover assembly is configured to exert a force on the PCB to secure the PCB against the inner ring-shaped housing; and
an outer ring-shaped housing surrounding at least a portion of the cover assembly, the outer ring-shaped housing defining at least a portion of an outer curved surface of the wearable ring device.

15. The wearable ring device of claim 14, wherein the one or more optical lenses are formed at least partially within the one or more apertures of the inner ring-shaped housing, wherein the PCB is detachably coupled with the inner ring-shaped housing to align the one or more sensors with the one or more optical lenses.

16. The wearable ring device of claim 15, wherein forming the one or more optical lenses are formed via an injection molding procedure, an epoxy molding procedure, or both.

17. The wearable ring device of claim 15, wherein the one or more optical lenses comprise one or more recesses configured to receive the one or more sensors, wherein the PCB is detachably coupled with the inner ring-shaped housing such that the one or more sensors are disposed at least partially within the one or more recesses of the one or more optical lenses.

18. The wearable ring device of claim 14, wherein the one or more optical lenses are formed at least partially over the one or more sensors of the PCB, wherein the PCB is detachably coupled with the inner ring-shaped housing such that the one or more optical lenses are disposed at least partially within the one or more apertures of the inner ring-shaped housing.

19. The wearable ring device of claim 14, further comprising:
a compressible material disposed between the PCB and the cover assembly, wherein the cover assembly causes the compressible material to compress and exert the force on the PCB to secure the PCB against the inner ring-shaped housing.

20. The wearable ring device of claim 14, further comprising:
a battery that is detachably coupled with the PCB, wherein the cover assembly is configured to exert the force on the battery to secure the battery against the inner ring-shaped housing.
